(19) United States
(12) Patent Application Publication
(10) Pub. No.: US 2003/0020560 A1
(43) Pub. Date: Jan. 30, 2003

(54) High speed electrical connection

(75) Inventor: Stephen Paul Marsh, Northants (GB)

Correspondence Address: FLESHNER & KIM, LLP, P. O. Box 221200, Chantilly, VA, 20153-1200, US

(73) Assignee: Bookham Technology plc

(21) Appl. No.: 10/201,077

(22) Filed: Jul. 24, 2002

(30) Foreign Application Priority Data
Jul. 25, 2001 (GB) 0118079.3

(51) Int. Cl. H01P 1/04

(52) U.S. Cl. 333/33; 333/247

(57) ABSTRACT

In electronic apparatus, a coaxial signal cable is connected to a semiconductor circuit using a coaxial connector 24 to convert the coaxial signal to a coplanar wave (CPW) mode, the CPW mode signal being transferred from the connector 24 to the circuit 27 via a flexible connection 23 comprising a CPW transmission line 25 on a flexible substrate 26.

### FIELD

This invention relates to high speed electrical signal connections in particular for use between coaxial cables and semiconductor integrated circuits.

### BACKGROUND OF THE INVENTION

A problem exists in the transfer of high speed electrical signals e.g 40 Gbits/s (range 30 kHz to 40 GHz) from coaxial cables to semiconductor chips whilst maintaining the quality of the signal. A conventional solution is shown in FIG. 1 of the accompanying drawings. The coaxial connector 10 is mounted in the metal wall 11 of the apparatus housing 12 with its metal signal pin 13 intruding into the housing. The pin 13 is then pressed onto, soldered to, or has a metal spring contact with a signal line 15 of a circuit board 16. The circuit board signal line 15 then butts up to a semiconductor chip 17 and the signal line 15 has a wire bond 19 to the signal line 18 on the chip 17. The signal return path to ground changes from the outer conductor of the coaxial cable to the metal wall 11 and then to the metal ground plane of the circuit board 16 and the metal ground plane of the chip. There is problem due to the impedance mismatch that occurs at the interface between the connector pin and the board transmission line and between the transmission line and the chip. These interfaces are shown in the circled areas A & B. At their interface the impedance, which is dependent on the relationship of the signal to the ground return, is not controlled or maintained.

The present invention provides a coaxial cable to semiconductor connection with an improved impedance match between high speed electrical signal on the cable and semiconductor integrated circuits.

### STATEMENTS OF INVENTION

According to a first aspect of the present invention there is provided in electronic apparatus, a method of connecting a coaxial signal cable to a semiconductor circuit in which method a coaxial connector is used to convert the coaxial signal to a coplanar wave (hereinafter CPW) mode, the CPW mode signal being transferred from the connector to the semiconductor circuit via a flexible connection comprising a CPW transmission line on a flexible substrate.

The field matching of the converted CPW mode signal to the transmission line promotes higher speeds of operation and has an advantage in that the use of a flexible connection within circuits will allow for wider manufacturing tolerances.

Preferably the CPW transmission line is connected to a semiconductor chip within the circuit by thermo-compression bonding.

The flexible connection preferably comprises the CPW line on a flexible printed circuit board (pcb) and conveniently, within said apparatus, the pcb also connects the connector to ground via the CPW ground tracks, to the chip ground, maintaining the correct impedance.

The flexible connection may be joined to the connector, by any suitable method for example soldering, prior to the connector being inserted through a wall of said apparatus.

The method is particularly suitable for the connection of coaxial connectors in relation to apparatus enclosed in electrically non-conductive housings since the ground contact is part of the connection.

According to another aspect of the invention there is provided an electronic apparatus including a housing, a coaxial connector extending through a wall of the housing, and a semiconductor circuit within the housing connected to said connector, the coaxial connector converting the coaxial signal to a CPW mode, and said connector being connected to the circuit by a CPW transmission line supported on a flexible substrate.

### DESCRIPTION OF THE DRAWINGS

The invention will be described by way of example and with reference to the accompanying drawings in which:

FIG. 1 is a schematic drawing showing a typical prior art connection between a coaxial connector and semiconductor chip, and

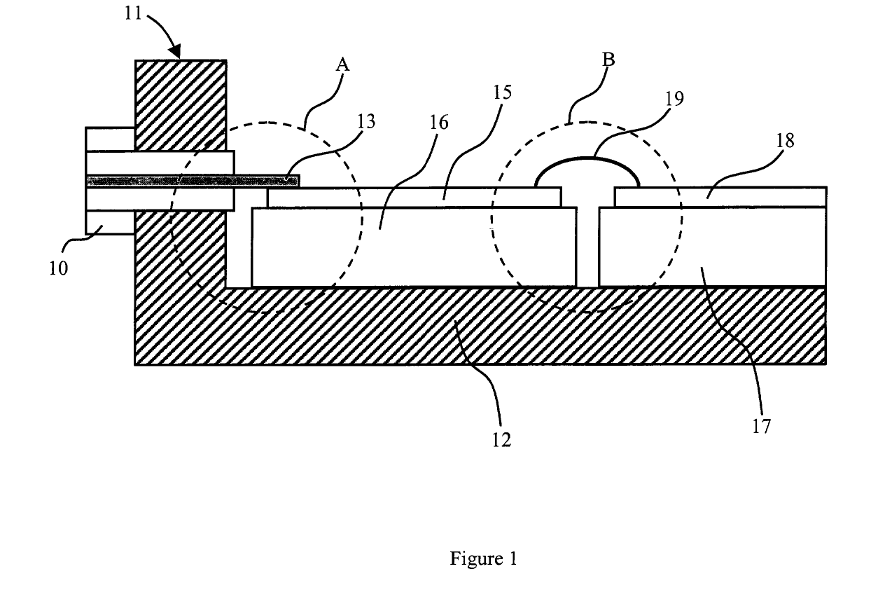

FIG. 2 is a schematic drawing showing a plan view of a coplanar wave transmission line, and

FIG. 3 is a schematic drawing showing a connection according to the present invention.

### DETAILED DESCRIPTION OF THE INVENTION

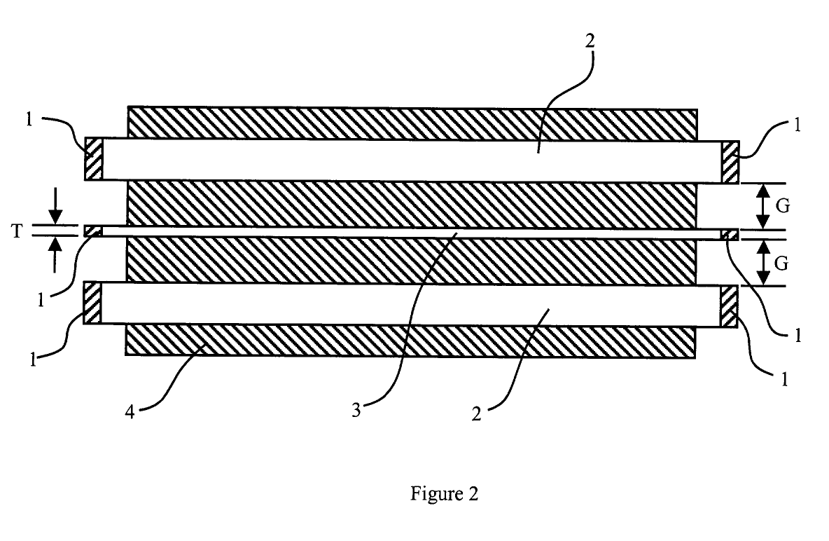

With reference to FIG. 2, there is shown a CPW transmission line comprising a signal track 3 located between two ground tracks 2. The tracks 2 & 3 are supported on a dielectric substrate 4. Typically, the tracks 2 & 3 will comprise thin metal layers formed on the dielectric substrate 4. In the present invention, the substrate 4 is a flexible polymeric layer and tracks 2 & 3 are in a fixed relationship but are physically flexible. The characteristic impedance of the CPW transmission line is proportional to the ratio T:G, where T is the signal track width and G is the ground track separation distance. The tracks 2 & 3 are provided with electrical connections 1 at the ends thereof for attachment to other components.

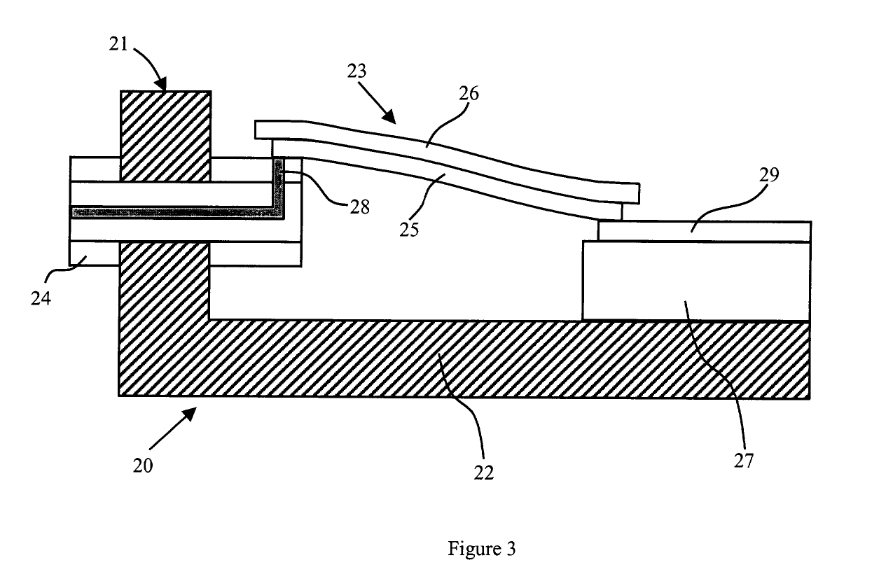

Referring now to FIG. 3, there is shown an electronic apparatus 20 having a housing 22 with a coaxial cable connector 24 extending through a wall 21 of the housing 22. The connector 24 contains a transition that converts the coaxial signal mode to a coplanar waveguide (CPW) mode. Such a connector is available from Rosenberger Hoch Frequenz Technik GmbH of Fridolfing, Germany.

The connector 24 is connected to a semiconductor chip 27 which is part of a semiconductor circuit, via a flexible connection 23. The connection 23 includes a CPW transmission line 25 and a supporting substrate 26. The CPW transmission line 25 is connected to the CPW mode signal outlet 28 of connector 24 by any suitable method, preferably by soldering, which gives a good interface with the connector 24 and reduces impedance mismatch in that area. The CPW transmission line is preferably a copper layer or a gold plated copper layer about 17 microns thick and is supported on a thin flexible substrate 26, preferably a pcb material such as PTFE (polytetrafluoroethylene) about 100 microns in thickness.

The other end of the CPW transmission line 25 is connected to a signal line 29 and ground contacts on the semiconductor chip 27, preferably by using thermo-compression bonding techniques so that the two lines 25 & 29 are fused together.

The above connection from coaxial cable to chip provides for an impedance matched path from coaxial connector to semiconductor chip.

The pcb substrate 26 may also be provided with a ground path (not shown) allowing the connector and flexible connection 23 to be used in a nonconductive housing, preferably made from a plastics material. This is because the connection 23 maintains the ground contact integrity that is normally provided by a metal housing.

In assembly, one end of the flexible connection 23 may be pre-soldered to the connector 24 and then the connector 24 inserted through an aperture in the wall 21 of the housing 22. The other end of the connection 23 is then compression bonded to the chip. This provides a quick and simple method of manufacture which effectively eliminates manufacturing dimensional tolerance relating to the interconnection of connector 24 to chip 27.

1. In electronic apparatus, a method of connecting a coaxial signal cable to a semiconductor circuit in which method a coaxial connector is used to convert the coaxial signal to a coplanar wave (hereinafter CPW) mode, the CPW mode signal being transferred from the connector to the circuit via a flexible connection comprising a CPW transmission line on a flexible substrate.

2. A method as claimed in claim 1 wherein the CPW transmission line is connected to a semiconductor chip within the circuit by thermo-compression bonding.

3. A method as claimed in claim 1 or claim 2, wherein the flexible connection comprises the CPW line on a flexible printed circuit board (pcb).

4. A method as claimed in any one of claims 1 to 3 wherein the flexible connection is joined to the connector prior to the connector being inserted through a wall of said apparatus.

5. A method as claimed in claim 4, and which is utilised with coaxial connectors for apparatus enclosed in electrically non-conductive housings.

6. Electronic apparatus including a housing, a coaxial connector extending through a wall of the housing, and a semiconductor circuit within the housing connected to said connector, the coaxial connector converting the coaxial signal to a CPW mode, and said connector being connected to the circuit by a flexible connection comprising a CPW transmission line supported on a flexible substrate.

7. Apparatus as claimed in claim 6 wherein the flexible connection comprises a CPW transmission line on a pcb.

8. Apparatus as claimed in claim 7 wherein the pcb provides a ground path for the coaxial connector.

9. Apparatus as claimed in any one of claims 6 to 8 wherein the CPW transmission line is secured to a signal line on the circuit by a thermo-compression joint.

10. Apparatus as claimed in claim 8 or any claim depending therefrom, wherein the housing is formed from an electrically non-conductive material and the pcb provides ground integrity for the coaxial connector.
